(19) United States
(12) Patent Application Publication
(10) Pub. No.: US 2022/0198518 A1
(43) Pub. Date: Jun. 23, 2022

(54) Systems And Methods For Displaying Targeted Advertisements On A Vehicle

(71) Applicant: Ford Global Technologies, LLC, Dearborn, MI (US)

(72) Inventors: Anthony Prozzi, Hayward, CA (US); Jacky Yang, Mountain View, CA (US); Catherine Charette, Tracy, CA (US); Jack Somers, San Fernando, CA (US); John Galin, Mill Valley, CA (US)

(73) Assignee: Ford Global Technologies, LLC, Dearborn, MI (US)

(21) Appl. No.: 17/132,595

(22) Filed: Dec. 23, 2020

(51) Int. Cl. G06Q 30/02

(52) U.S. Cl. CPC G06Q 30/0265; G06Q 30/0271

(57) ABSTRACT

This disclosure is generally directed to systems and methods for displaying targeted advertisements on a vehicle. In an example method in accordance with the disclosure, a camera that is mounted on the vehicle captures an image of an individual who may have a view of an exterior portion of the vehicle (such as a side portion, a front-facing portion, or a rear-facing portion). The image is evaluated by a controller based on various classification criteria such as, for example, an ethnicity, an age bracket, and/or a gender of the individual. The controller may further evaluate an audio clip of the individual captured by a microphone mounted on the vehicle. A targeted advertisement that specifically targets the individual is selected based on the evaluation of the image and/or the audio clip. The targeted advertisement is displayed on the exterior portion of the vehicle that is viewable by the individual.

### FIELD

This disclosure generally relates to advertisements displayed on a vehicle and more particularly relates to targeted advertisements displayed on a vehicle.

### BACKGROUND

The phrase targeted advertisement generally refers to advertisements that have been customized so as to appeal to specific interests of individual customers. For example, a targeted advertisement may be displayed upon a display screen of a computer based on one or more actions performed by an individual upon the computer. The actions can include, for example, browsing a subject of interest, purchasing an item online, searching for a product, clicking on an existing advertisement, and expressing interest in a certain subject and/or product on a social media platform. The effectiveness of this approach in customizing and displaying targeted advertisements depends in large part on actions performed by the individual upon the computer.

Another form of advertisement that is directed at reaching a wider audience involves providing advertisements on vehicles, such as, for example, a billboard mounted upon a vehicle or a sign painted upon a vehicle. Such advertisements may be viewed by various people as the vehicle travels in various areas. Typically, in the interests of offering a broader appeal, these advertisements may be displayed in a format that is aimed at a general populace. For example, a vehicle that is driven in an English-speaking area may contain an advertisement in English. The English language advertisement may be effective is several areas where English is spoken predominantly but may be ineffective when the vehicle is traveling in an area where English is not the most commonly spoken language, such as, for example, in an area where the people predominantly speak Spanish. Furthermore, replacing the advertisement with a different advertisement involves removal of the billboard or painted sign, followed by replacement, which can be expensive and cumbersome.

Electronic billboards placed upon vehicles provide some level of flexibility but here again the advertisements are typically predefined and may be ineffective when the advertisement is irrelevant to a target audience such as an English language advertisement that is irrelevant to a target audience that speaks Spanish.

It is therefore desirable to provide solutions that address at least some shortcomings in traditional forms of advertisement on vehicles.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an example vehicle that supports displaying of targeted advertisements in accordance with an embodiment of the disclosure.

FIG. 2 illustrates some example cameras that may be provided on a vehicle in accordance with an embodiment of the disclosure.

FIG. 3 illustrates an example scenario where an audience is present around a vehicle displaying targeted advertisements in accordance with an embodiment of the disclosure.

FIG. 4 shows some example components that may be included in a vehicle that supports targeted advertisements in accordance with an embodiment of the disclosure.

FIG. 5 shows a flowchart of an example method to display targeted advertisements upon a vehicle in accordance with an embodiment of the disclosure.

### DETAILED DESCRIPTION

### Overview

In terms of a general overview, certain embodiments described in this disclosure are directed to systems and methods for displaying targeted advertisements on a vehicle. In an example method, a camera that is mounted on the vehicle captures an image of an individual who may have a view of a first exterior portion of the vehicle (such as, a side portion, a front-facing portion, or a rear-facing portion of the vehicle). The image is evaluated by a controller based on various classification criteria such as, for example, an ethnicity, an age bracket, and/or a gender of the individual. The controller may further evaluate an audio clip of the individual to identify a language spoken by the individual. The audio clip may be captured by a microphone mounted on the vehicle. A targeted advertisement that specifically targets the individual is selected based on the evaluation of the image and the audio clip. The targeted advertisement is displayed on the exterior portion of the vehicle that is viewable by the individual.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words, terms, and labels should be interpreted as referring to various objects and actions that are generally understood in various forms and equivalencies by persons of ordinary skill in the art. For example, the label “vehicle” as used in this disclosure encompasses any of various types of vehicle. such as, for example, a car, a sports utility vehicle (SUV), a truck, a van, a semi-trailer truck, a bus, a scooter, and an autonomous vehicle of any kind. The word “individual” as used herein is not limited to a pedestrian but also includes any person or creature who can view a targeted advertisement on a vehicle (such as, for example, an occupant of a vehicle that is in the vicinity of a vehicle displaying a targeted advertisement, or a pet animal). The word “image” as used herein can refer to a single digital image or to a video clip containing multiple digital images. The word “advertisement” as used herein encompasses “visual content” that may be displayed on a display screen of a vehicle and/or “audio content” that can be transmitted out of one or more speakers mounted on the vehicle. Other examples of visual content may include images associated with events, news, and announcements, for example. The word “example” as used herein is intended to be non-exclusionary and non-limiting in nature.

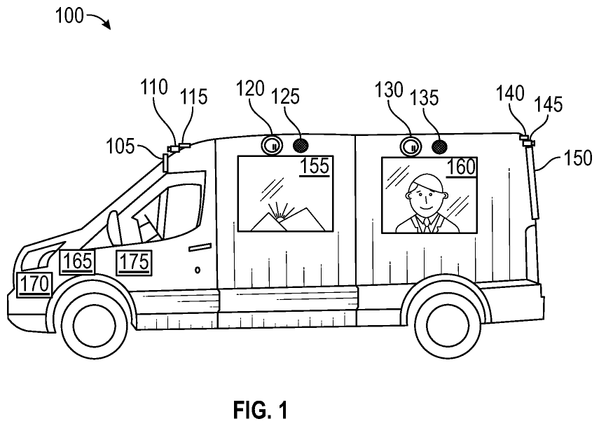

FIG. 1 shows an example vehicle 100 that supports displaying of targeted advertisements in accordance with an embodiment of the disclosure. Some example components that may be provided in the vehicle 100 can include a vehicle computer 170, an advertisement controller 165, a communication system 175, and various components associated with displaying targeted advertisements on display screens that are viewable from outside the vehicle 100.

The vehicle computer 170 may perform various functions such as, for example, controlling engine operations (fuel injection, speed control, emissions control, braking, etc.), managing climate controls (air conditioning, heating etc.), activating airbags, and issuing warnings (check engine light, bulb failure, low tire pressure, vehicle in blind spot, etc.). In applications where the vehicle 100 is an autonomous vehicle, the vehicle computer 170 may control various movements and actions performed by the autonomous vehicle.

The advertisement controller 165 may operate individually, or in cooperation with the vehicle computer 170, to execute various operations in accordance with the disclosure. In some cases, some, or all, of the components of the advertisement controller 165 may be integrated into the vehicle computer 170.

The communication system 175 can include wired and/or wireless communication devices mounted in or on the vehicle 100 in a manner that support various types of communications such as, for example, communications between the advertisement controller 165 and/or the vehicle computer 170. The communication system 175 may utilize one or more of various wired and/or wireless technologies such as, for example, Bluetooth®, Ultra-Wideband (UWB), Wi-Fi, Zigbee®, Li-Fi (light-based communication), audible communication, ultrasonic communication, and/or near-field-communications (NFC).

The advertisement controller 165 and/or the vehicle computer 170 can also utilize the communication system 175 to communicate with components that may be located outside the vehicle 100, such as, for example, a cloud-based server computer (not shown). Such communications may be carried out via a communications network (not shown). The communications network may include any one network, or a combination of networks, such as, for example, a local area network (LAN), a wide area network (WAN), a telephone network, a cellular network, a cable network, a wireless network, and/or private/public networks such as the Internet. The communications network may support one or more types of communication technologies such as, for example, Bluetooth®, Ultra-Wideband, cellular, near-field communication (NFC), Wi-Fi, Wi-Fi direct, Li-Fi, machine-to-machine communication, and/or man-to-machine communication. At least one portion of the communications network may include a wireless communication link that allows the cloud-based server computer to communicate with the advertisement controller 165 and/or the vehicle computer 170. The cloud-based server computer may communicate with the advertisement controller 165 and/or the vehicle computer 170 for various purposes such as, for example, to provide information related to targeted advertisements.

In the example configuration shown in FIG. 1, the advertisement controller 165 may communicate with various display screens on the vehicle 100 in order to display targeted advertisements in accordance with the disclosure. The display screens can be provided in various forms such as, for example, in the form of display devices that are attached to the vehicle 100 or display devices that are an integral part of the vehicle 100.

In an example implementation in accordance with the disclosure, the advertisement controller 165 is communicatively coupled to a camera 120 that may be mounted at various locations on the vehicle 100 (such as, for example, above the display screen 155, behind the display screen 155, below the display screen 155, the roof of the vehicle 100, or at any other spot on the chassis of the vehicle 100). The camera 120 is generally arranged to capture images of one or more individuals who may be present in the vicinity of the vehicle 100 and are able to view the display screen 155 if they so desire. The camera 120 can be any of various devices such as, for example, a video camera that produces video clips, a digital camera that captures digital images, a wide-angle camera that captures images of a group of individuals, a camera with a zoom feature that permits image capture of a subset of a group of individuals (such as, for example, a single individual). Other devices such as, for example, an infrared sensor, a radar sensor, an ultrasonic sensor, and/or a light detection and ranging (LIDAR) sensor may be used in lieu of the camera 120 or in addition to the camera 120.

The advertisement controller 165 may also be communicatively coupled to a microphone 125 that can be mounted at various locations on the vehicle 100 (such as, for example, above the display screen 155, behind the display screen 155, below the display screen 155, the roof of the vehicle 100, or at any other spot on a side panel of the vehicle 100). In an example implementation, the microphone 125 may be located adjacent to the camera 120 in order to capture audio associated with one or more individuals whose images are captured by the camera 120. In another example implementation, the camera 120 may be a part of an integrated system that includes, for example, the camera 120, the microphone 125, the display screen 155, and/or one or more sensors. In some instances, the camera or other sensors may be motion activated. The microphone 125 is generally arranged to capture voices of one or more individuals who may be present in the vicinity of the vehicle 100 and are able to view the display screen 155 if they so desire. The microphone 125 can be an omnidirectional microphone in some cases, and a unidirectional microphone in some other cases. The omnidirectional microphone may capture voices of multiple individuals who may be present in the vicinity of the vehicle 100. The unidirectional microphone may capture a voice of any specific individual who may, in some cases, a part of a group of individuals.

In an example method of operation in accordance with the disclosure, the advertisement controller 165 may transmit a command to the camera 120 to initiate image capture of an individual and/or a group of individuals who may be present in the vicinity of the vehicle 100 and are able to view the display screen 155 if they so desire. The advertisement controller 165 may also transmit a command to the microphone 125 to capture audio associated with the individual and/or the group of individuals. The audio can include speech of the individual(s) and may also include other sounds that may be present in the vicinity of the vehicle 100.

The images captured by the camera 120 are conveyed to the advertisement controller 165, which evaluates these images based on one or more classification criteria. Some examples of classification criteria may include an ethnicity, an age bracket, and/or a gender of one or more individuals who can view the display screen 155 and/or are approaching or facing the vehicle. Audio captured by the microphone 125 may be evaluated by the advertisement controller 165 in order to perform operations such as, for example, identifying a language spoken by one or more individuals.

The advertisement controller 165 may then select an advertisement based on the evaluation. For example, the advertisement controller 165 may select a targeted advertisement based on determining an age bracket of one or more individuals in a group of individuals. If the age bracket corresponds to an adult category, the targeted advertisement may be a product advertisement such as, for example, a brand of coffee, a brand of cigarette, or an alcohol product. However, if the age bracket corresponds to a child category, advertising products such as coffee, cigarette or alcohol may be deemed inappropriate, and the advertisement controller 165 may instead select a targeted advertisement corresponding to a product such as, for example, a cereal, a brand of footwear, or a baby food.

As another example, the advertisement controller 165 may select a targeted advertisement based on determining an ethnicity and/or a language spoken by one or more individuals. If, for example, the ethnicity is Hispanic and the spoken language is Spanish, the advertisement controller 165 may select a targeted advertisement that may be of interest to Hispanics and contains Spanish language audio content. Audio capture via the microphone 125 may be omitted in some implementations where deemed unnecessary for performing certain operations in accordance with the disclosure such as, for example, when adequate information for selecting and displaying a targeted advertisement is available via evaluation of captured images (age, ethnicity, etc.).

In an example embodiment, the advertisement controller 165 may display a targeted advertisement in response to identifying one or more features in a captured image. For example, the advertisement controller 165 may display a targeted advertisement of one entity in response to detecting an element of another competing entity in a captured image. Thus, for example, the advertisement controller 165 may display a paid advertisement for UPS® upon detecting a Fedex® logo on another vehicle, or may display a paid advertisement for Peet's Coffee® upon detecting a Starbucks® logo on a building near the vehicle 100. In another example, the advertisement controller 165 may display a train schedule upon identifying a train station in an image captured at a location where the vehicle 100 is stopped. In yet other example, the advertisement controller 165 may display an advertisement for nearby tourist attractions upon identifying one or more tourists in a captured image.

In the example configuration shown in FIG. 1, the display screen 155, the camera 120, and the microphone 125 are shown mounted upon a front portion of a side panel on one side of the vehicle 100. This side may be referred to as a left side of the vehicle. Additional display screens, cameras, and/or microphones may be mounted on other portions of the vehicle 100, such as for example, a display screen 160 that is mounted upon a rear portion of the side panel on the left side. A camera 130 and a microphone 135 may also be provided together with the display screen 160. Operations associated with the display screen 160, the camera 130, and the microphone 135 may be substantially similar to operations described above with respect to the display screen 155, the camera 120, and the microphone 125. The display screen 160 may be provided primarily to display targeted advertisements directed at one or more individuals who may be present in the vicinity of the rear portion of the vehicle 100 (such as, for example, at a bus stop where people are getting into the vehicle 100 via a rear door of the vehicle 100). On the other hand, the display screen 155 may be provided primarily to display targeted advertisements directed at one or more individuals who may be present in the vicinity of the front portion of the vehicle 100 (such as, for example, at a pedestrian crossing in front of the vehicle 100, when the vehicle 100 is stopped at a traffic light). Any number and combination of displayed may be used herein.

Another display screen 150 may be mounted upon a rear-facing portion of the vehicle 100 such as, for example, a rear door panel or a rear window. A camera 145 and a microphone 140 may also be provided together with the display screen 150. Operations associated with the display screen 150, the camera 145, and the microphone 140 may be substantially similar to operations described above with respect to the display screen 155, the camera 120, and the microphone 125. The display screen 150 may be provided primarily to display targeted advertisements directed at one or more individuals who may be present behind the vehicle 100 such as, for example, an occupant of another vehicle that is stopped behind the vehicle 100 at a traffic light.

A display screen 105 may be mounted upon a front-facing portion of the vehicle 100 such as, for example, above a front windshield of the vehicle 100. A camera 110 and a microphone 115 may also be provided together with the display screen 105. Operations associated with the display screen 105, the camera 110, and the microphone 115 may be substantially similar to operations described above with respect to the display screen 155, the camera 120, and the microphone 125. The display screen 105 may be provided primarily to display targeted advertisements directed at one or more individuals who may be present in front of the vehicle 100 such as, for example, an occupant of another vehicle that is stopped on the other side of a road and facing the vehicle 100 at a traffic light.

One or more display screens, cameras, and/or microphones may be mounted upon a side panel on the other side of the vehicle 100 that is not visible in the illustration shown in FIG. 1. This other side may be referred to as a passenger side of the vehicle 100. Operations associated with a display screen, cameras and/or microphone provided on the passenger side of the vehicle 100 may be substantially similar to operations described above with respect to the display screen 155, the camera 120, and the microphone 125. Targeted advertisements displayed on a display screen (or display screens) on the passenger side of the vehicle 100 may be primarily directed at one or more individuals who may be present on the passenger side of the vehicle 100 such as, for example, an occupant of another vehicle that is stopped beside the vehicle 100 at a traffic light, or a pedestrian on a sidewalk on the other side of the road at the traffic light.

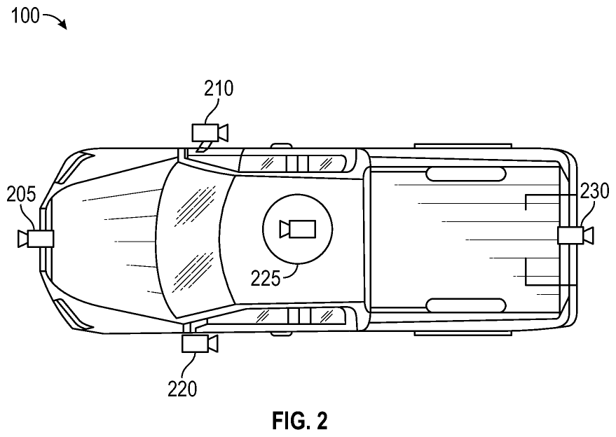

FIG. 2 illustrates some example cameras that may be provided on the vehicle 100 in accordance with an embodiment of the disclosure. These example cameras may be used in lieu of, or in addition to, the cameras shown in FIG. 1. A camera 220 located on a left side side-view mirror may have a field-of-view that encompasses a left side of the vehicle 100 and can capture images of one or more individuals that may be present on the left side of the vehicle 100. The images may be conveyed to the advertisement controller 165 that evaluates the image and displays a targeted advertisement on a display screen located upon the left side of the vehicle 100 (such as the display screen 155 and/or the display screen 160 described above).

A camera 210 located on a side-view mirror on the passenger side of the vehicle 100 may have a field-of-view that encompasses the passenger side of the vehicle 100 and can capture images of one or more individuals that may be present on the passenger side of the vehicle 100. The images may be conveyed to the advertisement controller 165 that evaluates the image and displays a targeted advertisement on one or more display screens located upon the passenger side of the vehicle 100.

A camera 205 located on a front bumper or a grille of the vehicle 100 may have a field-of-view that encompasses a front view of the vehicle 100 and can capture images of one or more individuals that may be present in front of the vehicle 100. The images may be conveyed to the advertisement controller 165 that evaluates the image and displays a targeted advertisement on a display screen located on a front portion of the vehicle 100 (such as, for example, above a windshield of the vehicle 100).

A camera 230 located on a rear bumper or a trunk of the vehicle 100 may have a field-of-view that encompasses a rear view of the vehicle 100 and can capture images of one or more individuals that may be present behind the vehicle 100. The images may be conveyed to the advertisement controller 165 that evaluates the images and displays a targeted advertisement on a display screen located on a rear portion of the vehicle 100 (such as, for example, above a window on the back of the vehicle 100).

A camera 225 located on a roof of the vehicle 100 may be mounted upon a rotatable platform that can be rotated under control of the advertisement controller 165 in order to orient the camera 225 in any of several directions. The camera 225 can be configured to capture images of individuals that may be present at various locations around the vehicle 100. In an example scenario in accordance with disclosure, the advertisement controller 165 may orient the camera 225 to capture images of individuals that may be present on a sidewalk when the vehicle 100 is stopped at a traffic light. The advertisement controller 165 may evaluate one or more images captured by the camera 225 and display one or more targeted advertisements on one or more display screens provided on the vehicle 100. Subsequently, the advertisement controller 165 may orient the camera 225 in a different direction so as to capture images of individuals that may be present behind the vehicle 100, for example. The advertisement controller 165 may evaluate one or more of these images and display one or more targeted advertisements on one or more display screens provided on the vehicle 100.

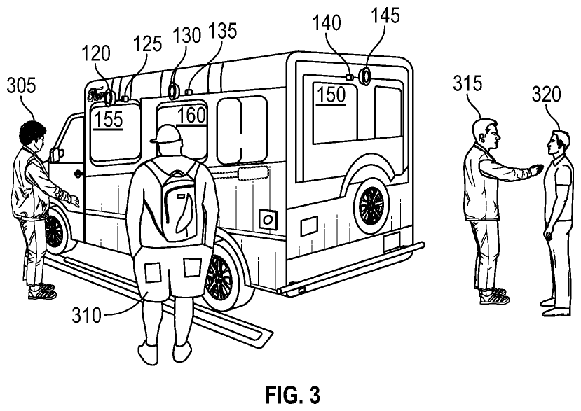

FIG. 3 illustrates an example scenario where an audience is present around the vehicle 100 that is displaying targeted advertisements in accordance with an embodiment of the disclosure. In this example scenario, an individual 305 is facing the vehicle 100 and has an unobstructed view of the left side of the vehicle 100 where the display screen 155 is located. The camera 120 may capture one or more images of the individual 305 and convey the image(s) to the advertisement controller 165. The advertisement controller 165 may evaluate the image(s) (and/or audio that may be captured by the microphone 125) and select a targeted advertisement based on classifying the individual 305, for example, as a Caucasian male who is older than 40 years. The targeted advertisement, which may be, for example, a medication for older people, may be displayed on the display screen 155. The targeted advertisement may also be selected on the basis of various other criteria, such as, for example, a sentiment or an emotion displayed by the individual 305 and/or a duration over which the individual 305 is looking towards the vehicle 100.

At a later instant in time, the individual 305 may move away from the vehicle 100 and another individual (a middle-aged woman, for example) may move close to the vehicle 100 and in view of the camera 120. The woman may have an unobstructed view of the display screen 155. The camera 120 may capture one or more images of the woman and convey the image(s) to the advertisement controller 165. The advertisement controller 165 may evaluate the image(s) (and/or audio that may be captured by the microphone 125) and select a targeted advertisement based on classifying the woman as middle-aged. The advertisement controller 165 may then replace the targeted advertisement of the medication for older people, with another targeted advertisement such as, for example, an item of clothing for women.

Another individual 310 may be standing near the individual 305. The individual 310 is closer towards the rear of the vehicle 100 and has an unobstructed view of the display screen 160 that is located on a rear portion of the vehicle 100. The camera 130 may capture one or more images of the individual 305 and convey the image(s) to the advertisement controller 165. The advertisement controller 165 may evaluate the image(s) (and/or audio that may be captured by the microphone 135) and select a targeted advertisement based on classifying the individual 305 as a Hispanic male, for example. The targeted advertisement, which may be, for example, an upcoming sports event, may be displayed on the display screen 160. The individual 310 may view the targeted advertisement on the display screen 160 while the individual 305 is concurrently viewing the targeted advertisement (medication, for example). In some cases, displaying of the advertisement upon the display screen 160 may be executed sequentially after displaying of the first advertisement upon the display screen 155. The sequential display may be used to produce a dynamic advertisement that moves (rolls) from one display screen to another.

An individual 315 who is located behind the vehicle 100 is shown walking away from the vehicle 100. On the other hand, an individual 320 who is also located behind the vehicle 100 is shown looking towards the display screen 150 mounted upon the rear portion of the vehicle 100. The camera 145 may capture one or more images that include the individual 315 and the individual 320. The advertisement controller 165 may evaluate the image(s) (and/or audio that may be captured by the microphone 140) and determine that the individual 315 is not facing the display screen 150. Consequently, the advertisement controller 165 may disregard the individual 315 and evaluate the individual 320 for purposes of selecting a targeted advertisement that is directed at the individual 320. The targeted advertisement may be displayed on the display screen 150 for viewing by the individual 320.

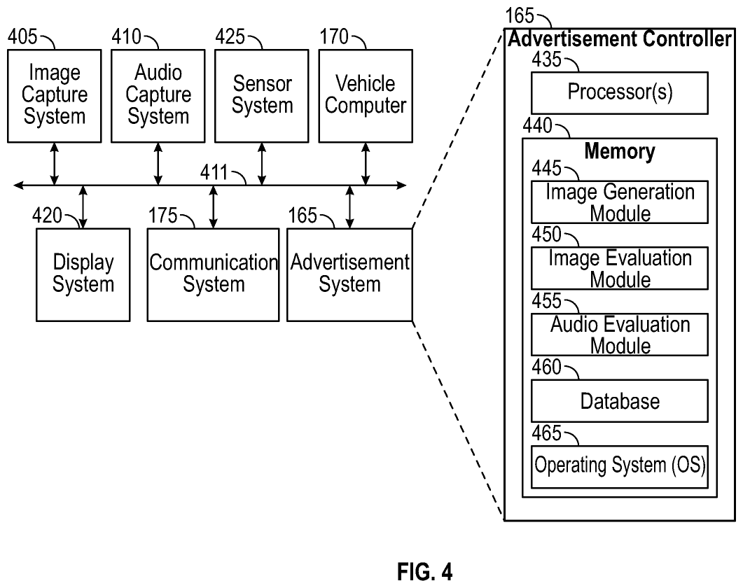

FIG. 4 shows some example components that may be included in the vehicle 100 that supports targeted advertisements in accordance with an embodiment of the disclosure. The example components may include the vehicle computer 170, the advertisement controller 165, the communication system 175, an image capture system 405, an audio capture system 410, a sensor system 425, and a display system 420. The various components are communicatively coupled to each other via one or more buses such as an example bus 411. The bus 411 may be implemented using various wired and/or wireless technologies. For example, the bus 411 can be a vehicle bus that uses a controller area network (CAN) bus protocol, a Media Oriented Systems Transport (MOST) bus protocol, and/or a CAN flexible data (CAN-FD) bus protocol. Some or all portions of the bus 411 may also be implemented using wireless technologies such as Bluetooth®, Bluetooth®, Ultra-Wideband, Wi-Fi, Zigbee®, or near-field-communications (NFC). For example, the bus 411 may include a Wi-Fi communication link that allows the advertisement controller 165 to wirelessly communicate with the vehicle computer 170.

The image capture system 405 may include one or more cameras such as, for example, the camera 120, the camera 130, and other cameras described above. Each of these cameras may operate under control of the advertisement controller 165, such as, for example, carry out image capture operations when image capture commands are received from the advertisement controller 165. The captured images of any one or more of cameras can be propagated to the advertisement controller 165 via the bus 411. In some applications, the images may be propagated to the advertisement controller 165 in real time, such as, for example, in the form of a video stream. In some applications, various settings of a camera such as, for example, a zoom setting or a focus setting, may be controlled by the advertisement controller 165.

The audio capture system 410 may include one or more microphones such as the microphone 125, the microphone 135, and other microphones described above. Each of these microphones may operate under control of the advertisement controller 165, such as, for example, record audio of individuals standing in front of a display screen (voices, for example). The audio captured by a microphone can be propagated to the advertisement controller 165 via the bus 411. In some applications, the audio may be propagated to the advertisement controller 165 in real time, such as, for example, in the form of an audio stream. In some applications, various settings of a microphone such as, for example, a directional characteristic of the microphone, may be controlled by the advertisement controller 165. In some applications, the audio capture system 410 may be omitted where deemed unnecessary for performing certain operations in accordance with the disclosure such as, for example, when adequate information is available from captured images (age, ethnicity, etc.).

The sensor system 425 may include various types of sensors such as, for example, infrared sensors, radar sensors, ultrasonic sensors, light detection and ranging (LIDAR) sensors, that may be used to detect the presence of individuals near the vehicle 100. The sensor system 425 may propagate sensor signals to the advertisement controller 165 via the bus 411. in an exemplary embodiment, one or more sensors of the sensor system 425 may be configured to trigger image capture by one or more cameras of the image capture system 405.

The display system 420 may include one or more display screens such as, for example, the display screen 155, the display screen 160, and other display screens described above. Each display screen may operate under control of the advertisement controller 165, such as, for example, to display targeted advertisements. In some applications, targeted advertisements may be propagated from the advertisement controller 165 in real time, such as, for example, in the form of a sequence of images. In some applications, various settings of a display screen such as, for example, image resolution, image brightness, and image contrast may be controlled by the advertisement controller 165.

The communication system 175 can include wired and/or wireless communication nodes mounted upon the vehicle 100 in a manner that allows the advertisement controller 165 and/or the vehicle computer 170 to communicate with each other via the bus 411. The communication system 175 may use one or more of various wired and/or wireless technologies such as Bluetooth®, Ultra-Wideband (UWB), Wi-Fi, Zigbee®, Li-Fi (light-based communication), audible communication, ultrasonic communication, or near-field-communications (NFC). The communication system 175 can also include wireless components that allow the advertisement controller 165 to communicate with various devices via a network such as, for example, the Internet.

The advertisement controller 165 may include various components such as, for example, a processor 435 and a memory 440. The memory 440, which is one example of a non-transitory computer-readable medium, may be used to store an operating system (OS) 465 and various code modules such as, for example, an image generation module 445, an image evaluation module 450, and an audio evaluation module 455. The code modules are provided in the form of computer-executable instructions that can be executed by the processor 435 for performing various operations in accordance with the disclosure. The memory 440 may also include a database 460.

The image generation module 445 may be executed by the processor 435 in order to generate images pertaining to targeted advertisements that may be displayed on one or more display screens of the display system 420. The images may be generated by obtaining data stored in the database 460 and/or obtained from one or more devices (a server computer, for example) via a network such as the Internet. Such data may include information such as, for example, classification criteria, preferences, historical data, and/or product information.

The image evaluation module 450 may be executed by the processor 435 in order to evaluate images provided to the advertisement controller 165 by the image capture system 405. The image evaluation module 450, which may cooperate with image processing hardware (not shown) in some cases, can include various types of image processing code such as, for example, filtering algorithms and image editing software. In an example scenario, the image evaluation module 450 may be executed by the processor 435 in order to identify one or more characteristics such as, for example, a physical attribute, an ethnicity, an age bracket, and/or a gender of one or more individuals contained in one or more images. The images may be evaluated by obtaining data stored in the database 460 and/or obtained from one or more devices via a network such as the Internet. In an example application, data may be obtained from a server computer containing public records of various individuals (age, ethnicity, gender, etc.).

The audio evaluation module 455 may be executed by the processor 435 in order to evaluate audio provided to the advertisement controller 165 by the audio capture system 410. The audio evaluation module 455, which may cooperate with audio processing hardware (not shown) in some cases, can include various types of audio processing code such as, for example, a language recognition system, filtering algorithms, and audio editing software. In one example scenario, the audio evaluation module 455 may be executed by the processor 435 in order to identify one or more characteristics such as, for example, a spoken language of one or more individuals contained in one or more images. In some cases, the audio may be evaluated by obtaining data stored in the database 460 and/or obtained from one or more devices via a network such as the Internet.

The database 460 may include data pertaining to various topics associated with targeted advertising such as, for example, various advertisements, classification criteria, statistical data, historical data, preferences of various types of individuals, ethnic preferences, product information, and/or language information.

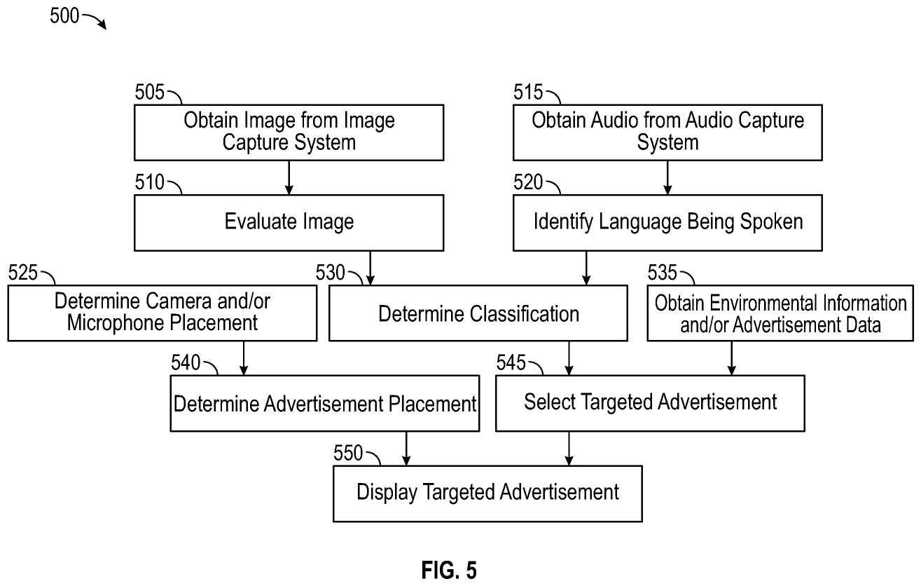

FIG. 5 shows a flowchart 500 of an example method to display a targeted advertisement on a vehicle in accordance with an embodiment of the disclosure. The flowchart 500 illustrates an example sequence of operations that can be implemented in hardware, software, or a combination thereof. In the context of software, the operations represent computer-executable instructions stored on one or more non-transitory computer-readable media such as the memory 440, that, when executed by one or more processors such as the processor 435, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flowchart 500 may be executed by the advertisement controller 165 and other components described above. The operations indicated in the flowchart 500 have been described by referring to the vehicle 100 and the example components described above (particularly with reference to FIG. 4). However, it must be understood that the flowchart 500 is equally applicable to various other vehicles and various other embodiments in accordance with the disclosure.

At block 505, the advertisement controller 165 may obtain one or more images captured by the image capture system 405. In some cases, the images may be captured in response to image capture commands issued by the advertisement controller 165. The image capture commands may be issued based on various guidelines, regulations, and/or conditions. For example, in one embodiment, the advertisement controller 165 may issue image capture commands only when the vehicle 100 is in a stopped state. Doing so may not only provide the advertisement controller 165 adequate time to generate targeted advertisements but may also ensure that a target audience has adequate time to view the displayed targeted advertisements.

In another example embodiment, the advertisement controller 165 may issue image capture commands only when one or more individuals are standing in the vicinity of the vehicle 100 and have an unobstructed view of one or more display screens provided on the vehicle 100. For example, the advertisement controller 165 may issue an image capture command to the camera 120 upon receiving a sensor signal from the sensor system 425 that indicates the presence of the individual 305 near the vehicle 100 (when the vehicle 100 is in a stopped state). The advertisement controller 165 may refrain from sending image capture commands to other cameras under circumstances such as, for example, when no audience is present in front of a display screen or when one or more display screens are located on the passenger side of the vehicle 100 and the vehicle 100 is in motion. Capturing images of people in passing vehicles may be deemed irrelevant because these people may not have adequate time to view a targeted advertisement.

In yet another embodiment, the advertisement controller 165 may configure one or more cameras to stay on continuously so as to obtain real time video that can be evaluated in order to display targeted advertisements on one or more display screens (including display screens that can be viewed by people in passing vehicles).

At block 510, images obtained from one or more cameras may be evaluated by the advertisement controller 165. The evaluation may be carried out by the processor 435 executing the image evaluation module 450.

At block 515, the advertisement controller 165 may obtain audio from one or more microphones. In some implementations, this step may be omitted when audio is not used for generating targeted advertisements.

At block 520, audio obtained from one or more microphones may be evaluated by the advertisement controller 165. The evaluation may be carried out by the processor 435 executing the audio evaluation module 455. In an example implementation, a voice recognition application such as, for example, software applications provided by Dragon® and Google® may be used to identify a language spoken by one or more individuals.

At block 530, the advertisement controller 165 may determine a classification that is based on evaluating one or more images and one or more audio clips. The evaluation may be carried out by the processor 435 executing the image generation module 445 and/or another code module stored in the memory 440. A few example classifications can include, for example, age (baby, young child, teenager, adult, etc.), race (Caucasian, Asian, African, etc.), gender (male or female), and language (English, Spanish, Urdu, etc.).

At block 535, environmental information (such as, for example, GPS information) and/or advertisement data may be obtained by the advertisement controller 165. In some applications, the data may be stored in the database 460 and/or in other databases. Environmental data can include various types of data pertaining to an area in which the vehicle 100 is providing targeted advertisements. In an example scenario, the environmental data may indicate that the vehicle 100 is parked in a neighborhood where most of the people have Chinese ethnicity. In another scenario, the environmental data may provide information about the weather in an area where the vehicle 100 is parked. If the weather is wet and cold, for example, the advertisement controller 165 may selectively display advertisements such as, for example, hot coffee and warm clothing. In some cases, information pertaining to the weather may be used by the advertisement controller 165 to modify some settings of one or more display screens (brightness, contrast, etc.).

Advertisement data stored in the database 460 and/or in other databases may provide information about the nature and applicability of various advertisements in various scenarios.

At block 545, the advertisement controller 165 may select a targeted advertisement that is directed at one or more individuals currently present in the vicinity of the vehicle 100.

At block 525, the advertisement controller 165 may determine camera and/or microphone placement (if not known already). For example, the advertisement controller 165 may determine that the camera 120 and the microphone 125 are associated with the display screen 155, and that the camera 130 and the microphone 135 are associated with the display screen 160.

At block 540, the advertisement controller 165 may determine placement of one or more targeted advertisements upon one or more display screens. For example, the advertisement controller 165 may utilize information obtained via images captured by the camera 120 and/or audio from the microphone 125 to identify a display screen upon which it is desired to display a targeted advertisement. In some cases, the advertisement controller 165 may determine that a targeted advertisement should be displayed on multiple display screens based on shared characteristics between individuals located in front of these multiple display screens. The targeted advertisement may be a Spanish language advertisement when a significant number of individuals are present near the vehicle 100.

At block 550, the advertisement controller 165 may configure one or more display screens to display one or more targeted advertisements in the manner described above. In some cases, a targeted advertisement may be concurrently displayed on multiple display screens such as, for example, on the display screen 155 and the display screen 160.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 435, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 440, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method comprising:
capturing, by a first camera mounted to a vehicle, a first image and/or a first audio clip of a first individual located at a first distance from the vehicle;
determining, by a controller in communication with the first camera, that the first individual has an unobstructed view of a first display screen provided on a first exterior portion of the vehicle;
selecting, by the controller and based on a first element of the first image and/or the first audio clip, a first visual content that targets the first individual, wherein the first element comprises a first entity; and
displaying the first visual content upon the first display screen provided on the first exterior portion of the vehicle.

2. The method of claim 1, wherein the first visual content comprises a first advertisement and wherein selecting the first advertisement that targets the first individual based on the first element of the first image and/or the first audio clip comprises selecting the first advertisement based on a physical attribute of the first individual and/or a language spoken by the first individual.

3. The method of claim 2, wherein the physical attribute comprises an ethnicity, an age bracket, and a gender of the first individual.

4. The method of claim 1, wherein the first exterior portion of the vehicle is one of a side of the vehicle, a front-facing portion of the vehicle, or a rear-facing portion of the vehicle.

5. The method of claim 4, further comprising:
capturing, by a second camera mounted to the vehicle, a second image and/or a second audio clip of a second individual located at a second distance from the vehicle;
determining, by the controller in communication with the second camera, that the second individual has an unobstructed view of a second display screen provided on a second exterior portion of the vehicle;
selecting, by the controller and based on a second element of the second image and/or the second audio clip, a second visual content that targets the second individual, wherein the second element comprises a second entity; and
displaying the second visual content upon the second display screen provided on the second exterior portion of the vehicle.

6. The method of claim 5, wherein the first visual content comprises a first advertisement and the second visual content comprises a second advertisement, wherein the second exterior portion of the vehicle is different than the first exterior portion of the vehicle, and wherein displaying the second advertisement upon the second display screen is executed concurrently to displaying the first advertisement upon the first display screen.

7. The method of claim 5, wherein the first visual content comprises a first advertisement and the second visual content comprises a second advertisement, wherein the second exterior portion of the vehicle is different than the first exterior portion of the vehicle, and wherein displaying the second advertisement upon the second display screen is executed sequentially after displaying the first advertisement upon the first display screen.

8. A method comprising:
capturing, by a first camera mounted on a vehicle, a first image and/or a first audio clip of a first group of individuals who are located at a first distance from the vehicle;
determining, by a controller in communication with the first camera, that the first group of individuals has an unobstructed view of a first display screen provided on a first exterior portion of the vehicle;
selecting, by the controller and based on a first element of the first image and/or the first audio clip, a first advertisement that targets at least a first subset of the first group of individuals, wherein the first element comprises a first entity; and
displaying the first advertisement upon the first display screen provided on the first exterior portion of the vehicle.

9. The method of claim 8, wherein selecting the first advertisement that targets the at least the first subset of the first group of individuals comprises selecting the first advertisement based on a classification criterion.

10. The method of claim 9, wherein the classification criterion comprises an ethnicity, a spoken language, an age bracket, and a gender of one or more of the at least the first subset of the first group of individuals.

11. The method of claim 8, wherein the first exterior portion of the vehicle is one of a side of the vehicle, a front-facing portion of the vehicle, or a rear-facing portion of the vehicle.

12. The method of claim 11, further comprising:
capturing, by a second camera mounted to the vehicle, a second image and/or a second audio clip of a second group of individuals who are located at a second distance from the vehicle;
determining, by the controller in communication with the second camera, that the second group of individuals has an unobstructed view of a second display screen provided on a second exterior portion of the vehicle;
selecting, by the controller and based on a second element of the second image and/or the second audio clip, a second advertisement that targets at least a second subset of the second group of individuals, wherein the second element comprises a second entity; and
displaying the second advertisement upon the second display screen provided on the second exterior portion of the vehicle.

13. The method of claim 12, wherein the second exterior portion of the vehicle is different than the first exterior portion of the vehicle, and wherein displaying the second advertisement upon the second display screen is executed concurrently to displaying the first advertisement upon the first display screen.

14. A vehicle comprising:
a first camera arranged to capture a first image and/or a first audio clip of at least a first individual who is located at a first distance from the vehicle; and
a controller coupled to the first camera, the controller configured to determine that the first individual has an unobstructed view of a first display screen provided on a first exterior portion of the vehicle and to evaluate the first image and/or the first audio clip and to select, based on evaluating a first element of the first image and/or the first audio clip, a first advertisement that targets the first individual, wherein the first element comprises a first entity,
wherein the first display screen is configured to display the first advertisement under control of the controller.

15. The vehicle of claim 14, further comprising:
a first microphone arranged to capture the first audio clip of the first individual; and
a language recognition system configured to identify a first language spoken by the first individual based on evaluating the first audio clip, and wherein the controller is further configured to include in the first advertisement, a first audio content in the first language spoken by the first individual.

16. The vehicle of claim 15, further comprising:
a second microphone arranged to capture a second audio clip of a second individual, and wherein the language recognition system is configured to identify a second language spoken by the second individual based on evaluating the second audio clip, and further wherein the controller is configured to include in a second 47207152.1 advertisement, a second audio content in the second language spoken by the second individual.

17. The vehicle of claim 14, wherein the first exterior portion of the vehicle is one of a side of the vehicle, a front-facing portion of the vehicle, or a rear-facing portion of the vehicle.

18. The vehicle of claim 14, wherein the controller evaluates the first image based on a classification criterion comprising an ethnicity, an age bracket, and a gender of the first individual.

19. The vehicle of claim 14, further comprising:
a second camera arranged to capture a second image of at least a second individual who is located at a second distance from the vehicle; and
a second display screen provided on a second exterior portion of the vehicle, the second display screen configured to display a second advertisement that targets the second individual if the controller determines that the second individual has an unobstructed view of the second display screen provided on the second exterior portion of the vehicle, wherein the second advertisement is selected by the controller based on evaluating a second element of the second image.

20. The vehicle of claim 19, wherein the first exterior portion of the vehicle is one of a first side of the vehicle or a front-facing portion of the vehicle and the second exterior portion of the vehicle is one of a second side of the vehicle or a rear-facing portion of the vehicle.
